(19) United States
(12) Patent Application Publication
(10) Pub. No.: US 2022/0366441 A1
(43) Pub. Date: Nov. 17, 2022

(54) SYSTEMS AND METHODS FOR MOBILITY SERVICE DEMAND PREDICTION

(71) Applicant: Ford Global Technologies, LLC, Dearborn, MI (US)

(72) Inventors: James Fishelson, Ypsilanti, MI (US); Richard Twumasi-Boakye, Taylor, MI (US); Xiaolin Cai, Ann Arbor, MI (US); Andrea Broaddus, Berkeley, CA (US); Dhanush Harihar, Novi, MI (US); Mohammed Fayaj navaz, Dearborn, MI (US); Jon Coleman, Saline, MI (US); Amit Bhagwan, Dearborn, MI (US); Archak Mittal, Canton, MI (US)

(73) Assignee: Ford Global Technologies, LLC, Dearborn, MI (US)

(21) Appl. No.: 17/321,579

(22) Filed: May 17, 2021

(51) Int. Cl. G06Q 30/02; G06F 30/20

(52) U.S. Cl. CPC G06Q 30/0205; G06Q 30/0202; G06F 30/20

(57) ABSTRACT

Systems and methods for mobility service demand prediction are disclosed herein. An example method includes determining trips of an existing transportation mode for a geo fenced area that are poorly served. The trips that are poorly served can include any one or more of the trips with a moderately high trip density, a moderately high ratio of transit-private vehicle trips, and/or a moderately high ratio of transit-time to private vehicle travel times. The method can include modeling trips of a new transportation service for a geofenced area, determining, based on the modeling, when the trips of the new transportation service have at least one improved travel parameter relative the trips that are poorly served, as well as generating a mobility service demand prediction that is indicates how likely users are to adopt new transportation service in view of the existing transportation mode.

### BACKGROUND

As new mobility services are developed such as automated, electric, connected, and shared, it is important from a strategic perspective to understand who is most likely to utilize these services if they are to be successful in the eyes of the system operator, such as a government entity or private company.

The newer and more transformative the mobility service, the harder it is to predict how customers may utilize these services. Trying to evaluate trips that do not currently exist is difficult because there are no empirical or historical data to use for comparative purposes. That is, when a service does not exist validation data is not available. A traditional approach for estimating these trips/customers involves mode choice modeling that leverages stated preference surveys and existing travel patterns for understanding user behavior. This method not only takes time, but may be prone to errors since the new services do not exist and may not be adequately described in the surveys. Estimating demand incorrectly is a massive risk, and planners could expend capital to deploy services in places where such services are simply not wanted.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an illustrative architecture in which techniques and structures for providing the systems and methods disclosed herein may be implemented.

FIG. 2 depicts an example scenario and architecture for mobility service demand prediction.

FIG. 3 is a mapped graph illustrating poorly service existing transportation modes produced using a geographic information system tool.

FIG. 4 is a table related to the mobility service demand prediction that provides results for transit complementary services.

FIG. 5 is another table related to the mobility service demand prediction that depicts an overview of transit system performance and measurements.

FIG. 6 is a flowchart of an example method of the present disclosure.

FIG. 7 is a flowchart of yet another example method of the present disclosure

### DETAILED DESCRIPTION

### Overview

The present disclosure is generally directed to systems and methods that implement analytical processes to identify expected demand for a new mobility service, or compare the efficacy of two or more modes of transportation In general, the systems and methods herein may identify what are referred to as ‘pain points’ in current transportation systems. These pain points can be remedied using new mobility services, but only if those riders currently using transportation systems are likely to use these new mobility services.

Some systems and methods can be adapted to identify expected demand for new mobility services. Instead of surveying riders how they would use a new mode, a series of algorithms and heuristics are used to estimate behavior based on user trip behavior (e.g., which rides they choose and which they do not).

The systems and methods disclosed herein can leverage analytical frameworks to determine potential market segments and demand for new mobility services using available data on current travel patterns by mode. These systems and methods can be utilized to effectively determine pain points, i.e. “gaps” in service for which no mode is a viable or preferred option.

The analytical frameworks can include identifying which trips are currently bad for all modes (i.e., there are no good solutions for a given trip), as well as identifying gaps in service quality. A gap in service quality could include, but is not limited to, a large number people taking a given mode of transportation even though it has an objectively low quality of service. This results in a set of trips that are attractive opportunities for new mobility services.

Critical and unanswered questions around deployment of new mobility services revolve around understanding and estimating who is most likely to take these new services, such as shared automated vehicles, dynamic shuttles, and scooters—just to name a few. Some approaches for estimating these trips/customers is mode choice logic modeling that leverages stated preference surveys and existing travel patterns to understanding user behavior. Though time-consuming, this method is reasonable where the modes are well-established and thus relative utilities are predictable. For example, one can be fairly confident how many people may chose private vehicles over trains for a given trip, since we have data against which to validate. Illustrative Embodiments

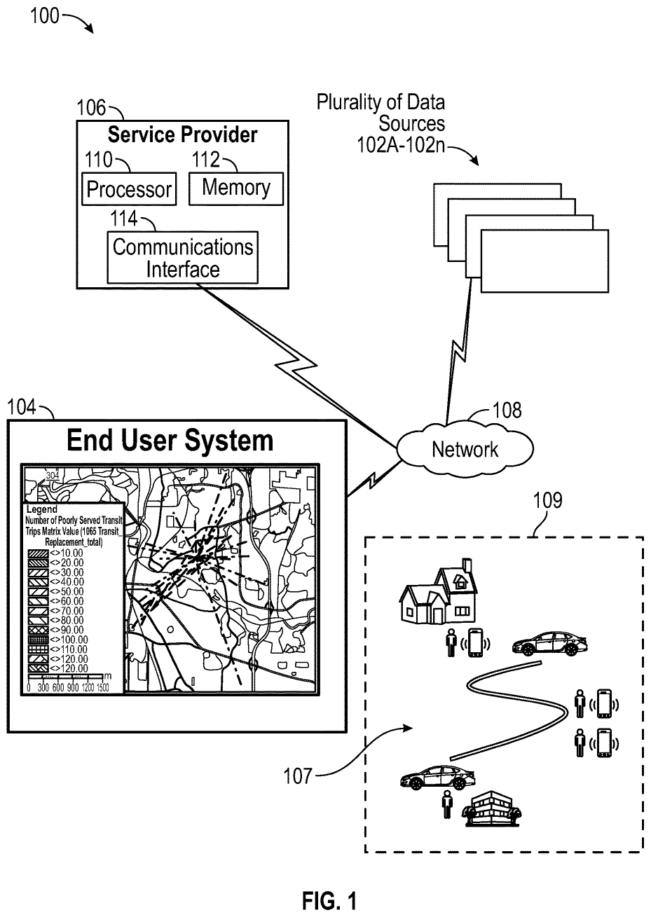

Turning now to the drawings, FIG. 1 depicts an illustrative architecture 100 in which techniques and structures of the present disclosure may be implemented. The architecture 100 can include a plurality of data sources 102A-102n, an end user system 104, as well as a service provider 106. Some or all of these components in the architecture 100 can communicate with one another using the network 108. The network 108 can include combinations of networks that enable the components in the architecture 100 to communicate with one another. The network 108 may include any one or a combination of multiple different types of networks, such as cable networks, the Internet, wireless networks, and other private and/or public networks. In some instances, the network 108 may include cellular, Wi-Fi, or Wi-Fi direct.

The plurality of data sources 102A-102n can include a publically-maintained transportation data management system, a census database, surveys, and the like, along with any other database or resource that provides transportation usage data. The plurality of data sources 102A-102n can also include proprietary data sources that include transportation usage data that can be similar to or different to those stored in the publically-maintained resources. To be sure, the plurality of data sources 102A-102n can include any type of relevant data that may be pertinent in identifying and predicting user response to new transportation modes. For clarity and brevity, the data obtained from any of the plurality of data sources 102A-102n, regardless of the type will be referred to hereinafter as transportation input data.

The plurality of data sources 102A-102n can each provide their respective types of transportation input data to the service provider 106. In general, the service provider 106 comprises a processor 110 and memory 112. The processor 110 executes instructions stored in the memory 112 to provide the transportation demand analysis methods disclosed herein. When referring to operations performed by the service provider 106 it will be understood that this includes execution of instructions by the processor 110. The service provider 106 can further comprise a communications interface 114 that allows the service provider 106 to interface with the network 108. Each of the plurality of data sources 102A-102n can transmit transportation input data to the service provider 106 over the network 108. A large variety of data can be used a base for the analytical framework implemented by the service provider 106. These data can include and reflect data for travel demand models for metropolitan regions, which include (but is not limited to) origin-destination matrices for trips, trip type by mode and time of day, and/or trip type by demographic just to name a few.

In general, the service provider 106 receives the transportation input data and processes the transportation input data using algorithms and heuristics, which will be described in greater detail infra. As noted above, rather than using stated user preferences (e.g., surveys) the service provider 106 can reveal user preferences (or willingness to adopt new services) using an analytical framework. This process provides a technical improvement over existing systems and methods that rely on stated user preferences. The computation of users' preferences for a more efficient service can be based on traveler tolerance thresholds on existing travel, mode options. For example, the service provider 106 can calculate transit delay ratios for many existing transportation modes in a given area. When these transit delay ratios exceed a traveler tolerance threshold, the existing transportation modes are identified as providing poor service to riders. In another technical improvement, the existing transportation modes in a given area can be compared against one or more proposed/new transportation modes. The same transit delay ratios can be calculated for the proposed/new transportation modes. If the proposed/new transportation modes have improved transit delay ratios compared to the existing transportation modes, the proposed/new transportation modes may be predicted as likely to be used by travelers/riders.

That is, the transit delay ratios of the bus service have trips that have transit delay ratios that exceed a traveler tolerance threshold. On the other hand, the scooter service provides trips that have transit delay ratios that are likely not to exceed a traveler tolerance threshold (e.g., the traveler would prefer the transit delay ratios of the scooter service because it does not exceed their traveler tolerance threshold when compared with the bus service).

As an example, the service provider 106 can be used to evaluate how users may respond to a new shared mobility service 107 that is being studied for deployment in a geo fenced area 109 within a city. The boundaries of the geo fenced area can be user-defined and can vary according to each analysis.

To be sure, asking or trying to predict how people may use a new mode may be fundamentally flawed (e.g., as with stated preference surveys). The service provider 106 implements algorithms and heuristics to estimate behavior based on what trips people currently take or do not take (e.g., as with stated preference surveys). Thus, instead of expressly using mode choice (which predicts which mode people may take for a given trip), the service provider 106 may determine which trips are currently unacceptable for all (or some) available modes of transportation, but nevertheless users still take these trips using the modes of transportation. Processes for quantifying or ascribing whether a trip is unacceptable or not will also be described in greater detail herein. The service provider 106 can identify different approaches which define different opportunities (e.g., trips/transportation mode(s)), as well as input variables that can include new mobility service types, trip types the new service could be replacing, service areas, and so forth.

For example, the service provider 106 can implement one or more algorithms to determine trips that are objectively bad (e.g. poorly served). One example algorithm includes the service provider 106 determining which trips involve (a) a moderately high trip density; (b) a moderately high ratio of transit-private vehicle trips, and (c) a moderately high ratio of transit time to private vehicle travel times.

In some instances, the service provider 106 can compare a proposed new service to each of a plurality of available (existing) transportation types. For example, an e-scooter service can be compared against any one or more of walking, bus routes, private, cars, ride hailing services, and so forth. In general, any new, proposed service can be compared to any existing, available transportation service. Broadly, the service provider 106 can obtain transportation input data for each of the existing, available transportation modes of which the proposed new service may replace.

In one specific example, e-scooters may be suggested a new mobility service to replace walk trips in a central business district. A system configured in accordance with the present disclosure can determine undesirable walk trips. i.e., those that are popularly taken but longer than typical walk trips. This could include, for example, walk trips with having any of one or more of the following attributes: (a) trips with a moderately high trip density, (b) a moderately high ratio of walk-other trips, and (c) travel times above a given cutoff (e.g., 10 minutes, also referred to as a transit time threshold). To be sure, each of these attributes can have values that can be selected and tuned as desired. This method may take into account variables, for example such as T_transit—Transit trips, T_transittime—Transit travel time, T_cartime—Car travel time, T_transitd—Transit trip density, Dᵢⱼ—Transit delay ratio, R—Threshold for transit trip selection, S—Threshold for transit trip density, W—Threshold for number of transit trips, and A—Area of Zone, i—origin zone, j—destination zone—just to name a few.

The service provider can be configured to determine T_transittime and T_cartime using a travel demand model for each origin-destination group with available transit options. The service provider 106 can then compute an actual transit delay ratio D for each origin-destination pair: Dᵢⱼ=T_transittime/T_cartime. This delay ratio between origin-destination pairs represents the decision threshold for determining users preference for efficient new mode option. This captures the framework or analysis for assessing poorly served trips.

Next, the service provider 106 can determine the threshold R, which is a ratio of transit travel time compared to car travel time, representing traveler's tolerance for inefficient transit trips (these data can be determined by surveys. as an example). The service provider 106 can determine an origin-destination pair with Dᵢⱼ≥R, and use it as filter for a dataset that include the travel demand, for transit trips.

In an example use case, the service provider 106 can be used to evaluate whether a dynamic shuttle service can replace traditional transit, such as a train, bus, taxi, or the like. The service provider 106 can determine transit trips that are currently taken but poorly served, as noted above such as transit trips with any one or more of (a) moderately high trip density, (b) a moderately high ratio of transit-private vehicle trips, and/or (c) a moderately high ratio of transit-time to private vehicle travel times. These existing, poorly served routes are then compared with an analysis of a proposed new transportation service.

The evaluation of transportation service includes two general steps. In a first step, the service provider 106 can determine intrazonal trips ∀, T trips in a geofenced area, choice of transit types/trips s.t., using the following equation where:

T_{transitd}≥S,S ∈(0, ∞]∀Tₜᵣₐₙₛᵢₜ: Tₜᵣₐₙₛᵢₜ∈T and Tₜᵣₐₙₛᵢₜ=0, where

$${T}_{{transitd}_{ij}} = \frac{{T}_{{transit}_{ij}}}{{A}_{i} + j}$$

In a second step, the service provider can determine ∀T_{transitd}≥S by computing Dᵢⱼ (delay ratio), where

$${D}_{ij} = \frac{{T}_{{transittime}_{ij}}}{{T}_{{cartime}_{ij}}} .$$

The service provider 106 can also determine ∀ intrazonal transit trips, Tₜᵣₐₙₛᵢₜ, where T_{transitd}≥S, and choose transit trips. The service provider 106 can also calculate Dᵢⱼ≥R and ∀i j pairs where Tₜᵣₐₙₛᵢₜ≥W. This delay ratio between origin-destination pairs Dᵢⱼ is compared to tolerance ratio R to determine areas of poorly served trips. Similarly, when new transportation service is implemented, this ratio is used to determine efficiency (or improvement) of travel due to new mode, in which case

$${D}_{ij} = \frac{{T}_{{newmodetime}_{ij}}}{{T}_{{cartime}_{ij}}} .$$

In another detailed use case, the aforementioned algorithms can be used by the service provider to determine if an e-scooter service can be used to replace walking routes, or whether e-scooters can act as a first-mile last-mile connector to a traditional transportation option. In general, the service provider 106 can evaluate transportation input data to determine trips where one end is far from a transit line and one is close (i.e., close to transit in part but not well serviced) and where private vehicles are not an attractive option. The ‘closeness’ can be user-specified in some instances. These questions can be answered using a combinatory approach. First, the service provider 106 can identify all trips that could be served by scooters as a first-mile, last-mile connector, split into two trip types such as scooter-transit or scooter-transit-scooter.

Scooter-Transit can include trips that (a) have one and only one origin or destination within 0.25 miles of a high-frequency transit stop and/or (b) the other origin or destination between 0.25 and 3 miles of another high-frequency transit stop. Scooter-Transit-Scooter can include trips that have both origin and destination between 0.25 and 3 miles of a high frequency transit stop.

The service provider 106 can identify which of these trips are poorly served (e.g., riders use a service, but it provides objectively poor quality of service) by traditional transit but still taken by determining transit trips with (a) moderately high trip density, (b) a moderately high ratio of transit-private vehicle trips, and (c) a moderately high ratio of transit-time to private vehicle travel times. The service, provider 106 can then supplement the analysis with trips that explicitly include the walk-to-transit as an option, filtering all trips with walk times above 10 minutes (or other selected transit time threshold). The service provider 106 can use these populations to create a synthetic population to be served by scooters as a first-mile last mile service.

Using the equations mentioned above, in a first step the service provider 106 can determine or predict intrazonal trips V, T trips in a geofenced area, choice of walking types/trips using the following equation where:

T_{walkd}≥S,S∈(0, ∞]∀T_{walk}:T_{walk}∈T and T_{walk}>0, where

$${T}_{{walkd}_{ij}} = \frac{{T}_{{walk}_{ij}}}{{A}_{i} + j}$$

This first step can involve creating an artificial origin-destination matrix using filtering. Two classes of data can be evaluates such as walk-transit (WT) and walk-transit-walk (WTW). With respect to WT, the service provider 106 can evaluate origin-destination trips with any of an origin or destination with 0.25 miles of a high-frequency same transit line. The service provider 106 can also evaluate trips of other origin or destination pairs from between 0.25 miles and 3 miles of same high frequency transit line. The service provider 106 can perform analyses sequentially for some or all high frequency transit line(s).

With respect to WTW, the service provider 106 can evaluate trips with both origin and destination pairs from between 0.25 miles and 3 miles of same high frequency travel line and then perform analyses sequentially for all high frequency transit line. It will be understood that this methodology may exclude from the analyses any transfers between transit-lines (e.g. a walk-transit-transit) trips, though these transfers could be considered via a similar approach.

Using the equations above for step one, the service provider can evaluate V for a trips T in a geofenced area. The service provider 106 can choose a high-frequency for evaluation. An actual walk distance Walk_{accdistance} is 0.25 miles, ∀ T_{walk-transit}:T_{walk-transit}∈T and T_{walk-transit}>0, and choose walk-transit trips, T_{walk-transit-walk}_{ᵢⱼ}_{,s.t}. Again, the distance boundaries used by the service provider 106 include 0.25 miles≤T_{dist}_{ᵢⱼ}≤3 miles and ∀T_{walk-transit-walk}; T_{walk-transit-walk}∈T and T_{walk-transit-walk}>0.

In a second step, the service provider can determine ∀T_{twalkd}≥S by computing Dᵢⱼ such that,

$${D}_{ij} = \frac{{T}_{{walktime}_{ij}}}{{T}_{{cartime}_{ij}}}$$

or alternatively

$${D}_{ij} = \frac{{T}_{{walktime}_{ij}}}{{T}_{{othermodetime}_{ij}}}$$

(where the othermodetime is the time required to take another example mode of transportation available to the user). For example the evaluation can be performed for additional existing transportation modes.

In a more specific example, the service provider 106 can determine a prediction of intrazonal walk trips ∀, T_{walk}, where T_{walkd}≥S, and choose transit trips, s.t. The service provider 106 can also calculate Dᵢⱼ≥R and ∀i j pairs where T_{walk}≥W.

Once the data have been analyzed by the service provider 106, the service provider 106 may filter trips identified above and then attempt to identify current transit trips with any one or more of (a) moderately high trip density (density threshold), (b) a moderately high ratio of transit-private vehicle trips, and/or (c) a moderately high ratio of transit-time to private vehicle travel times. Once these trips have been processed by the service provider 106 to identify ‘bad’ modes of transportation, the service provider 106 can supplement these options with trips that explicitly include the walk-to-transit as an option. The service provider 106 can then filter all trips with walk times above 10 minutes. The service provider 106 can combine the trips identified in steps above to create a synthetic population to be served by scooters as a first-mile last mile service. In some instances, this includes origin-destination matrix or matrices generated above.

Once the service provider 106 determines which existing trips/transportation modes provide poor service to riders, the service provider 106 can model a new transportation service and determine if the new transportation service provides trips that show an improvement relative to the existing trips/transportation modes that provide poor service to riders. For example, if the existing trips/transportation modes have unacceptably long duration, does the new transportation service remedy these long durations? In another example, are riders using an existing service (such as a private car service or ride hailing service) despite these options being costly, because there are no viable existing transportation options that service various origin-destination pairs in a particular area? These and other similar questions can be modeling using the service provider 106. Moreover, the service provider 106 can also consider additional factors such as wait times or cost that may be incurred when using a new form of transportation. Thus, even though the new form of transportation may improve parameters of existing trips (e.g., origin-destination pairs), the cost, wait times, or availability may be prohibitive. It will further be understood that a modeler can define the parameters evaluated using the processes disclosed herein to answer any specific question related to whether a new mode of transportation will likely be adopted by users in a defined geographical area.

In general, the output generated by the service provider 106 includes mobility service demand prediction (how likely users are to adopt a new service in view of what is available already). The output of the service provider 106 can include a graphical and quantifiable representation of which trips (and where) are most attractive for new mobility services. These results can be presented in a standardized format that can be accessed by a user of the end user system 104. The end user system 104 can access the service provider 106 through an application or a user-facing interface provided by the service provider 106.

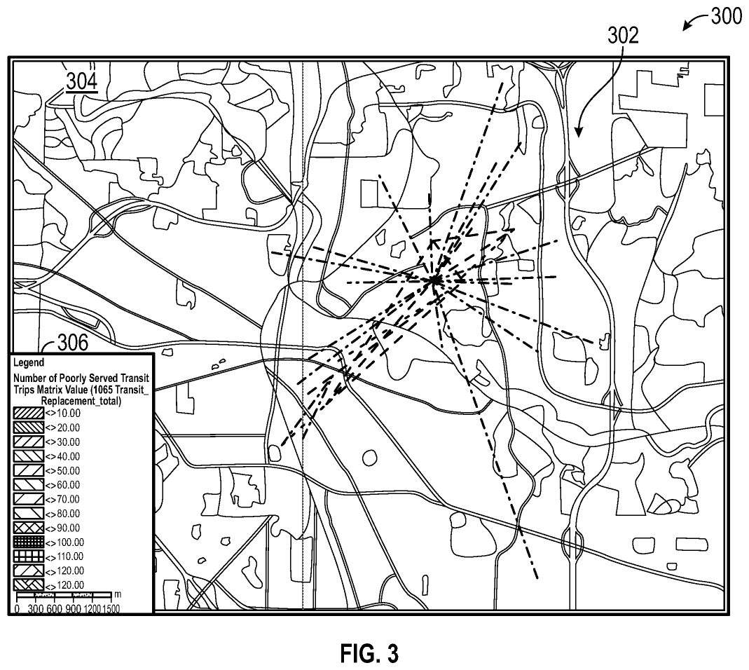

In some instances, the mobility service demand prediction being presented in a graphical format using a geographic information system tool (see FIG. 3). The geographic information system tool can depict spatio-temporal distribution of origin-destination demand flows at defined geographical units (e.g., traffic analysis zones, census block groups, block groups, hexagonal grids, etc.), desire lines representing flows between high opportunity areas, and spatial charts overlaying geographic units driven by databased with demand or trips for new service

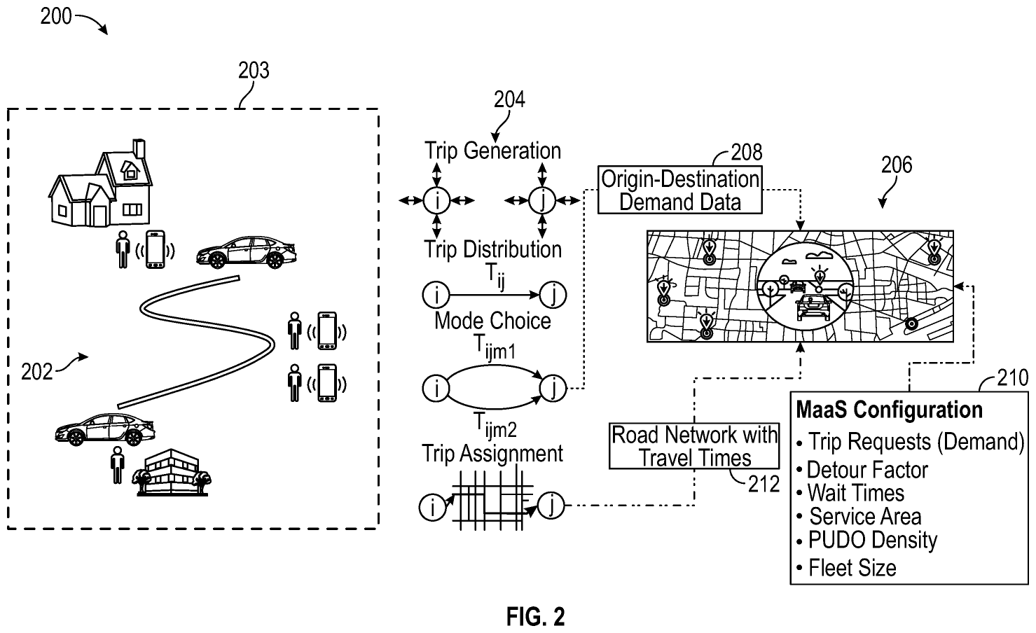

FIGS. 2-5 collectively illustrate an example scenario and architecture 200 for mobility service demand prediction. The scenario was created to simulate a new shared mobility service such as ride sharing for different scenarios and determine under which parameter constraints will the service be most efficient. The prediction can also be used to investigate the impact on operational, economic and traffic key performance indicators (KPIs).

This scenario focused on improving accessibility for transit trips that have excessively long travel times. The new service improves travel by minimizing the travel time from a factor of four compared to direct car trips, to a factor of 2 compared to car trips. That is, if a transit, trip was four times longer than a private ear trip for the poorly served origin-destination pairs, the new service only requires only twice as long as private car trips, significantly improving user experience. The demand profile(s) used is/are only from transit trips. These are fewer and more dispersed, resulting in a low occupancy. However, it is likely that the improved accessibility may also attract commuters leading to, mode shift from private vehicles to shared mobility.

In general, and as illustrated in FIG. 2, a city is proposed to have shared mobility services 202 for a geo fenced area 203. A service provider 106 can utilize travel demand modeling 204 that involves evaluating trip generation, trip distribution, mode choice, and trip assignments. A new mobility service modeler 206 is depicted. The new mobility service modeler 206 leverages the travel demand modeling 204 and transportation input data such as origin-destination pairs 208 and MaaS (Mobility-as-a-Service) configurations 210, as well as road network and travel time data 212. The MaaS configurations 210 can include, but are not limited to, trip requests (indicative of demand), detour factors, wait times, service areas, PUDO (Pickup and Dropoff) density, and fleet size_just to name a few.

These shared mobility services 202 include, but are not limited to autonomous ride hailing. For context, some transit trips can be time consuming with the added wait time, walk time, stop times especially when they include one or more transfers. In response, the service provider 106 can filter out transit trips that have four times as long the travel time compared to a direct car trips, and modeled a service targeting these demands. Compared to other scenarios, this case is directed to improving accessibility, rather than reducing congestion.

FIGS. 3-5 collectively illustrate output and results of an example transit complementary service analysis. This can include the determining poorly served transit trip estimations. In a first/initial step, the service provider can rank all origin-destination pairs by trip density, which includes transit trips per square mile. The service provider can then remove origin-destination pairs that fall below a given threshold. For example, the service provider can remove origin-destination pairs that have less than 75% of a specified mean trip density.

In a second step, the service provider can rank remaining origin-destination pairs by ratio of transit time to private vehicle time. It will be understood that the high ranking origin-destination pairs could indicate areas with higher underserved transit demand (i.e., people are still taking transit even though it performs poorly).

FIG. 3 is a mapped graph that illustrates these poorly served transit trip estimations. The mapped graph 300 was created using the architecture 200 of FIG. 2 The mapped graph 300 includes desire lines 302 that illustrate poorly served transit trips for a geo fenced area 304. A legend 306 is provided that indicates colors that are indicative of volume of poorly served transit trips in the geo fenced area 304. The range of values in the legend 306 can range from less than ten to greater than 120, although the range of the legend can vary as desired.

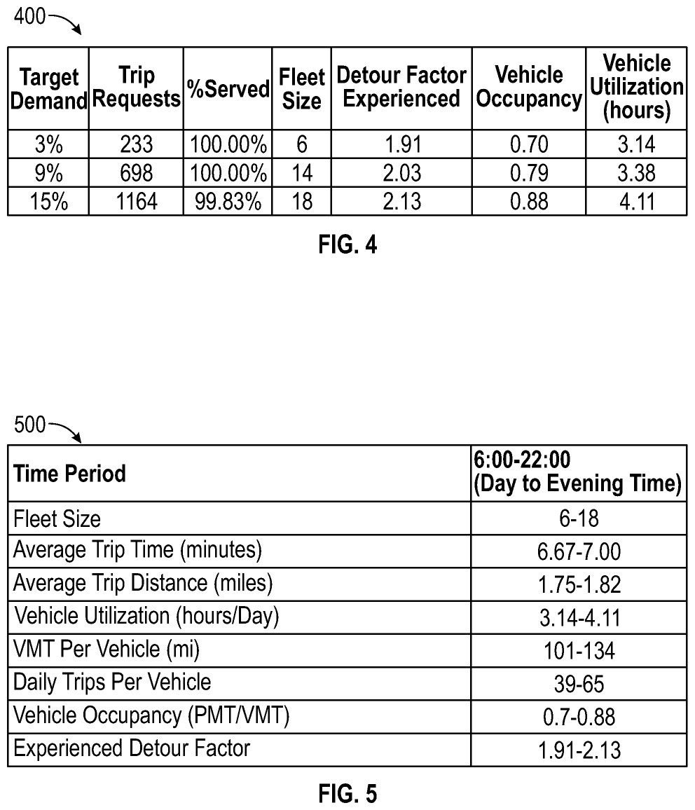

FIG. 4 illustrates a table 400 that provides results for transit complementary services based on example simulations using travel demand model data. That is, the table 400 includes a comparison of the poorly served transit trips with a new complementary service transit option. This example illustrates that experienced detour factors ranged from 1.9 to 2.1, which means this service may result in a significantly shorter travel time compared to the travel times between origin and destinations for the replaced transit option (e.g., poorly served transit trips). Detour factors represent a ratio of travel times due to sharing (i.e. detours to pick up other passengers in a pooling system) to direct travel time. Also, an average occupancy is lower as the demand is more scattered. FIG. 5 includes a table 500 that depicts an overview of transit system performance and measurements such fleet size, average trip time, average trip distance, vehicle utilization, vehicle miles per trip (VMT), daily trips per vehicle, vehicle occupancy, and experienced detour factor—these are key performance indicators obtained from simulating an alternative shared service option with demand data (obtained from travel demand models) from poorly served zones by transit (determined by analytical equations above). These mobility service parameters have been analyzed for a period of time from 6 pm to 10 pm, as an example.

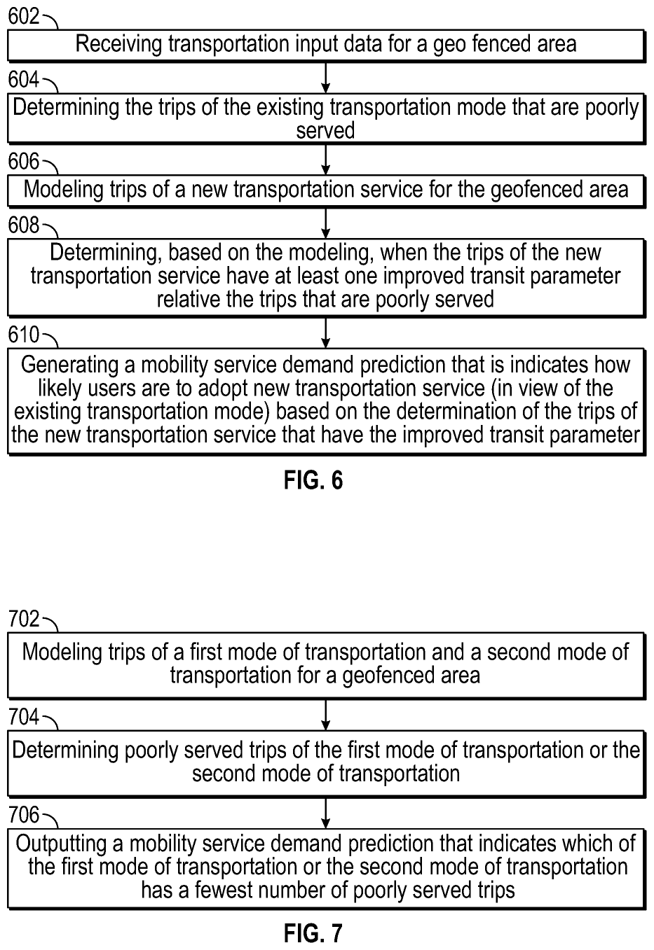

FIG. 6 is a flowchart of an example method of the present disclosure. The method can include a step 602 of receiving transportation input data for a geo fenced area. As noted above, the transportation input data can be received from one or more public and/or proprietary data sources. The transportation input data includes information that is indicative of trips available in the geo fenced area for an existing transportation mode.

The method can also include a step 604 of determining the trips of the existing transportation mode that are poorly served. Trips that are poorly served can include, for example trips with a moderately high trip density, a moderately high ratio of transit-private vehicle trips, and/or a moderately high ratio of transit-time to private vehicle travel times. In one example, a trip of an existing transportation mode can be identified as poorly serving a user when the existing transportation mode is compared to a user performing the same trip in a car.

The method can include a step 606 of modeling trips of a new transportation service for the geofenced area. The modeling can leverage demand data from travel demand models, or demand data from vendors in facilitating this analysis. The modeling can involve analyzing any one or more origin-destination matrices for the trips of the existing transportation mode, trip type by mode and time of day, and/or trip type by demographic. As noted above, the origin-destination matrices include origin-destination pairs, the method further comprising ranking the origin-destination pairs by trip density.

The method can also include a step 608 of determining, based on the modeling, when the trips of the new transportation service have at least one improved transit parameter relative the trips that are poorly served. For example, a new transit option may have shorter transit times than an existing transit option. In another example, a new transit option may have fewer connections than an existing transit option. For example, a new ridesharing service may be an improvement over an existing bus service because the bus service has too many stops which results in longer overall trip durations.

To be sure, improvement can be based on improvements in the parameters of origin-destination pairs. For example, the origin-destination pairs for the trips of the new transportation service are improved relative to the origin-destination pairs for the trips of the existing transportation service. An improvement could be related to reduced transit time, reduced cost, reduce wait time, and so forth. The mobility service demand prediction can also include parameters selected from any of fleet size, average trip time, average trip distance, vehicle utilization, vehicle miles per trip (VMT), daily trips per vehicle, vehicle occupancy, and experience detour factor—just to name a few.

The method can include a step 610 of generating a mobility service demand prediction that is indicates how likely users are to adopt new transportation service in view of the existing, transportation mode.

This can include a process that utilizes the equations similar to those set forth above. As noted above, the process can include determining transit times for one or more existing transportation mode, as well as for the same trips using a private vehicle car. An example travel demand model and equations are set forth above where a new mobility scooter option was compared to existing transportation modes.

This process can involve computing an actual transit delay ratio D for each origin-destination pair. For example, the transit delay ratio involves dividing the transit time of an existing transportation mode by a private vehicle mode, on a per-trip basis. Again, a trip includes an origin-destination pair. The method can include determining a threshold R, which is a ratio of travel time compared to car trip, representing traveler's tolerance for inefficient transit trips (can also be determined by survey). This is referred to generally herein determining traveler preference for efficient mode options. Next, the process can include identifying origin-destination pairs where the transit delay ratio is greater than the travelers tolerance threshold. This ratio can be used as filter for a dataset that include the travel demand of all transit trips. Thus the poorly served routes are origin-destination pairs where the origin-destination pairs have a transit delay ratio that is greater than the traveler's tolerance threshold. FIG. 7 illustrates another example flowchart of a method for comparing a first transportation service to a second transportation service. The method includes a step 702 of modeling trips of a first mode of transportation and a second mode of transportation for a geofenced area. The modeling can be based off of presumptive data or comparative data from other similar modes of transportation that may be available. This can include evaluating example origin-destination matrices that are comprised of origin-destination pairs, along with other modeling input.

The method can include a step 704 of determining poorly served trips of the first mode of transportation or the second mode of transportation. It will be understood that the poorly served trips have at least one or more of a moderately high trip density, a moderately high ratio of transit-private vehicle trips, and/or a moderately high ratio of transit-time to private vehicle travel times.

In one example, step 704 can include ranking all origin-destination pairs for trip density. For example, this can include calculating transit trips per square mile. Next, any origin-destination pairs that fall below a threshold can be removed. For example, any origin-destination pairs that have transit density that is less than 75% of a mean value of the trip density of all origin-destination pairs can be removed. Next. the process can include ranking the remaining origin-destination pairs by a transit delay ratio of transit time compared to private vehicle time. The highest ranking origin-destination pairs could indicate areas with higher underserved transit demand (i.e., people are still taking transit even though it performs poorly). The method can include a step 706 of outputting a mobility service demand prediction that indicates which of the first mode of transportation or the second mode of transportation has a fewest, number of poorly served trips. For example, if the first mode of transportation is determined to have 10 poorly served routes versus the second mode of transportation which is determined to have 30 poorly served routes, the first mode of transportation may be identified as the best option. Again, this conclusion can be-modified by evaluating other details such as cost, wait times, and so forth.

In the above disclosure, reference has been made to the accompanying drawings, which form a part hereof, which illustrate specific implementations in which the present disclosure may be practiced. It is understood that other implementations may be utilized, and structural changes may be made without departing, from the scope of the present disclosure. References in the specification to “one embodiment,” “an embodiment,” “an example embodiment,” and the like indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize a special purpose or general-purpose computer including computer hardware, such as, for example, one or more processors and system memory, as discussed herein. Implementations within the scope of the'present disclosure may also include physical and other computer-readable media for carrying or storing computer-executable instructions and/or data structures. Such computer-readable media can be any available media that can be accessed by a general-purpose or special-purpose computer system. Computer-readable media that stores computer-executable instructions are computer storage media (devices). Computer-readable media that carry computer-executable instructions is transmission media. Thus, by way of example, and not limitation, implementations of the present disclosure can comprise at least two distinctly different kinds of computer-readable media: computer storage media (devices) and transmission media.

Computer storage media (devices) includes RAM, ROM, EEPROM, CD-ROM, solid-state drives (SSDs) (e.g., based on RAM), flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data, links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium, Transmission media can include a network and/or data links, which can be used to carry desired program code means in the form of computer-executable instructions or data structures and which can be accessed by a general purpose or special purpose computer.

Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the, form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example. any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements. and/or steps. Thus, such conditional language is not generally intended to, imply that features, elements, and/or steps are in, any way required for one or more embodiments.

What is claimed is:

1. A method, comprising:
receiving transportation input data for a geo fenced area, the transportation input data being indicative of trips available in the geo fenced area for an existing transportation mode;
determining the trips of the existing transportation mode that are poorly served;
modeling trips of a new transportation service for the geo fenced area;
determining, based on the modeling, when the trips of the new transportation service have an improved transit parameter relative the trips that are poorly served; and
outputting a mobility service demand prediction that is indicates how likely users are to adopt new transportation service based on the determination of the trips of the new transportation service that have the improved transit parameter, the mobility service demand prediction being presented in a graphical format using a geographic information system tool.

2. The method according to claim 1, further comprising determining origin-destination matrices for the trips of the existing transportation mode from the transportation input data.

3. The method according to claim 2, further comprising selecting the trips to include in the origin-destination matrices according trip type by mode and time of day, and/or trip type by demographic.

4. The method according to claim 3, wherein determining the trips of the existing transportation mode that are poorly served includes filtering the origin-destination matrices to determine any one or more of:
one or more of the trips with a moderately high trip density,
a moderately high ratio of transit-private vehicle trips, and/or
a moderately high ratio of transit-time to private vehicle travel times.

5. The method according to claim 4, further comprising:
determining walk-to-transit trips that have a new transportation, service transportation transit time that is below a transit time threshold; and
determining a synthetic population of the users served by the new transportation service that is a combination of filtered results of the origin-destination matrices and the walk-to-transit trips.

6. The method according to claim 1, wherein determining the trips of the existing transportation mode that are poorly served comprises:
ranking origin-destination pairs of the trips by trip density within the geo fenced area;
determining the origin-destination pairs that are above a density threshold;
ranking the origin-destination pairs that are above the density threshold according to a ratio of transit time to private vehicle time, wherein, higher ranking origin-destination pairs are indicative users utilizing the existing transportation mode even though the existing transportation mode results in trips that are poorly served.

7. The method according to claim 1, wherein the improved transit parameter includes travel time, wherein when travel times for the trips of the new transportation service are shorter than the travel times for the trips of the existing transportation service the mobility service demand prediction will indicate that the users will likely adopt the new transportation service.

8. The method according to claim 1, wherein the improved transit parameter includes any one or more of shorter travel time, shorter travel distance, fewer transfers, and vehicle occupancy.

9. The method according to claim 1, further comprising outputting a mapped graph of the geo fenced area, the mapped graph comprising visual indications of the trips that are poorly served.

10. A system, comprising:
a processor; and
a memory for storing instructions, the processor executing the instructions to:
receive transportation input data, for a geo fenced area, the transportation input data being indicative of trips available in the geo fenced area for an existing transportation mode;
determine the trips of the existing transportation mode that are poorly served;
model trips of a new transportation service for the geofenced area;
determine, based on the modeling, when the trips of the new transportation service have an improved transit parameter relative the trips that, are poorly served; and
output a mobility service demand prediction that is indicates how likely users are to adopt new transportation service in view of the existing transportation mode.

11. The system according to claim 10, wherein the trips that are poorly served include any one or more of the trips with a moderately high trip density, a moderately high ratio of transit-private vehicle trips, and/or a moderately high ratio of transit-time to private vehicle travel times.

12. The system according to claim 10, wherein the processor is configured to perform the modeling for one or more additional existing transportation modes.

13. The system according to claim 10, wherein the transportation input data comprises any one or more of origin-destination matrices for the trips of the existing transportation mode, trip type by mode and time of day, and/or trip type by demographic.

14. The system according to claim 13, wherein the origin-destination matrices include origin-destination pairs, and the processor is configured to:
rank the origin-destination pairs by trip density; and
remove a portion of the origin-destination pairs that are below a density threshold.

15. The system according to claim 10, wherein the processor determines the trips of the existing transportation mode that are poorly served comprises by determining a ratio of transit travel time compared to car travel time.

16. A method, comprising:
modeling trips of a first mode of transportation and a second mode of transportation for a geofenced area;
determining poorly served trips of the first mode of transportation or the second mode of transportation, the poorly served trips having at least one or more of a moderately high trip density, a moderately high ratio of transit-private vehicle trips. and/or a moderately high ratio of transit-time to private vehicle travel times; and
outputting a mobility service demand prediction based on the determination of the trips of the second mode of transportation that have the improved transit parameter relative to the first mode of transportation.

17. The method according to claim 16, further comprising generating the mobility service demand prediction by:
determining a transit delay ratio for origin-destination pairs for each of the first mode of transportation and the second mode of transportation; and
determining the origin-destination pairs having a transit delay ratio that is greater than a traveler tolerance threshold, the traveler tolerance threshold being indicative of travelers tolerance for inefficient transit trips.

18. The method according to claim 16, further comprising evaluating origin-destination matrices for the trips of the first mode of transportation and the second mode of transportation for any one or more of trip type by mode and time of day, and/or trip type by demographic.

19. The method according to claim 18, wherein the origin-destination matrices include origin-destination pairs, the method further comprising ranking the origin-destination pairs by trip density.

20. The method according to claim 19, further comprising removing a portion of the origin-destination pairs that are below a density threshold.
